(19) United States
(12) Patent Application Publication
(10) Pub. No.: US 2010/0167150 A1
(43) Pub. Date: Jul. 1, 2010

(54) FUEL CELL SYSTEM

(75) Inventors: Sho Usami, Shizuoka-ken (JP); Tomohiro Ogawa, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA KABUSHIKI KAISHA, Toyota-shi, Aichi (JP)

(21) Appl. No.: 12/600,847

(22) PCT Filed: May 22, 2008
(86) PCT No.: PCT/JP2008/059849

§ 371 Date: Nov. 19, 2009

(30) Foreign Application Priority Data
May 25, 2007 (JP) 2007-139391

(51) Int. Cl. H01M 8/04

(52) U.S. Cl. 429/434; 429/513

(57) ABSTRACT

To provide a simple and compact fuel cell system that prevents degradation of the performance of a fuel cell stack due to accumulation of impurities and improves fuel efficiency by reducing discharge of a fuel gas.

An impurity storage section 30 that communicates with an outlet of an anode gas passage of each cell 20 and stores an impurity in a fuel gas is formed in a fuel cell stack 2. The volume of the impurity storage section 30 is preferably larger than the volume of a fuel gas inlet manifold 26.

### TECHNICAL FIELD

The present invention relates to a fuel cell system having a fuel cell stack composed of a plurality of cells. More specifically, it relates to a fuel cell system that operates with a fuel gas used by each cell for electric power generation effectively confined in a fuel cell stack.

### BACKGROUND ART

As disclosed in the patent documents listed below, for example, there are known fuel cell systems that operate with the fuel gas confined in the fuel cell stack and supply an amount of fuel gas to compensate for the consumption for electric power generation (referred to generically as dead-end system). In operation, nitrogen and other impurities are accumulated in the anode gas passage of each cell of the fuel cell stack of the dead-end system. If the impurities cover the surface of the MEA, the electromotive reaction on the electrode catalyst is inhibited, resulting in a decrease in voltage. In addition, an abnormal potential can occur and cause deterioration of the MEA. To avoid such problems and maintain adequate performance of the fuel cell stack, the impurities accumulated in the anode gas passages have to be discharged to the outside of the fuel cell stack at appropriate times.

However, discharging the impurities from the anode gas passages entails discharge of the fuel gas from the anode gas passages. Thus, frequent discharge results in poor fuel efficiency and therefore is undesirable. If the impurities are discharged after waiting until an adequate amount of impurities is accumulated, waste of the fuel gas can be reduced. That is, although accumulation of impurities is undesirable in terms of maintaining adequate performance of the fuel cell stack, the frequency of discharge is desirably minimized in terms of improving the fuel efficiency.

The Patent Document 1 discloses a system that can meet the contradictory two requirements, that is, prevention of degradation of the performance of the fuel cell stack due to accumulation of impurities and improvement of fuel efficiency by reducing discharge of the fuel gas. The system disclosed in the Patent Document 1 has a storage container (buffer) for storing impurities disposed in a discharge pipe for discharging the off-gas of the fuel gas from the fuel cell stack and a shut-off valve disposed downstream of the storage container. By guiding impurities in the fuel gas to the storage container disposed outside of the fuel cell stack, the concentration of impurities in the anode gas passages can be prevented from increasing, and the frequency of discharge by opening the shut-off valve can be reduced.

Patent Document 1: Japanese Patent Laid-Open No. 2005-243477

Patent Document 2: Japanese Patent Laid-Open No. 2006-12553

Patent Document 3: Japanese Patent Laid-Open No. 2005-353569

Patent Document 4: Japanese Patent Laid-Open No. 2005-353303

Patent Document 5: Japanese Patent Laid-Open No. Hei9-312167

### DISCLOSURE OF THE INVENTION

However, the system disclosed in the Patent Document 1 requires a space for the storage container that is separate from the fuel cell stack. Considering that the fuel cell system is used as a power source of a mobile body, such as automobile, the fuel cell system is preferably as simple in configuration and compact in size as possible.

The present invention has been devised to solve the problems described above, and an object of the present invention is to provide a simple and compact fuel cell system that prevents degradation of the performance of a fuel cell stack due to accumulation of impurities and improves fuel efficiency by reducing discharge of a fuel gas.

In order to attain the object described above, according to a first aspect of the present invention, there is provided a fuel cell system that has a fuel cell stack including a plurality of cells and operates with a fuel gas used by each cell for electric power generation effectively confined in the fuel cell stack, characterized in that the fuel cell system has an impurity storage section for storing an impurity in the fuel gas that is formed in the fuel cell stack and communicates with an outlet of an anode gas passage of each cell.

According to a second aspect of the present invention, in the first aspect of the present invention, the fuel cell system has a communicating mechanism that allows the impurity storage section to communicate with the outside of the fuel cell stack.

According to a third aspect of the present invention, in the first or second aspect of the present invention, a fuel gas inlet manifold for distributing the fuel gas supplied from the outside of the fuel cell stack to the anode gas passages of the cells is formed in the fuel cell stack, and the volume of the impurity storage section is larger than the volume of the fuel gas inlet manifold.

According to a fourth aspect of the present invention, in the third aspect of the present invention, an air inlet manifold for distributing air supplied from the outside of the fuel cell stack to cathode gas passages of the cells and an air outlet manifold for discharging air collected from the cathode gas passages of the cells to the outside of the fuel cell stack are formed in the fuel cell stack, and the volume of the impurity storage section is larger than the sum of the volumes of the fuel gas inlet manifold, the air inlet manifold and the air outlet manifold.

According to a fifth aspect of the present invention, in the fourth aspect of the present invention, a coolant inlet manifold for distributing a coolant supplied from the outside of the fuel cell stack to coolant passages of the cells and a coolant outlet manifold for discharging the coolant collected from the coolant passages of the cells to the outside of the fuel cell stack are formed in the fuel cell stack, and the volume of the impurity storage section is larger than the sum of the volumes of the fuel gas inlet manifold, the air inlet manifold, the air outlet manifold, the coolant inlet manifold and the coolant outlet manifold.

According to a sixth aspect of the present invention, in any one of the third to fifth aspects of the present invention, a choke is formed in a communicating part that communicates the fuel gas inlet manifold and the anode gas passage of each cell.

According to the first aspect of the present invention, since the impurities in the fuel gas are guided to the impurity storage section formed in the fuel cell stack, the concentration of impurities in the anode gas passages is prevented from increasing. As a result, the frequency of discharge of the off-gas of the fuel gas from the fuel cell stack can be reduced, and waste of the fuel gas can be reduced. In addition, a separate fuel gas outlet manifold for collecting anode off-gas from the outlets of the anode gas passages of the cells and guiding the anode off-gas to the impurity storage section is not necessary. Therefore, the entire system can be simple in configuration and compact in size.

According to the second aspect of the present invention, since the impurity storage section communicates with the outside of the fuel cell stack, the impurities accumulated in the impurity storage section can be discharged to the outside of the impurity storage section.

According to the third aspect of the present invention, since the volume of the impurity storage section is larger than the volume of the fuel gas inlet manifold, a large amount of impurities can be stored in the impurity storage section, and the frequency of discharge can be reduced accordingly.

According to the fourth aspect of the present invention, since the volume of the impurity storage section is larger than the sum of the volumes of the fuel gas inlet manifold, the air inlet manifold and the air outlet manifold, a larger amount of impurities can be stored in the impurity storage section, and the frequency of discharge can be further reduced.

According to the fifth aspect of the present invention, since the volume of the impurity storage section is larger than the sum of the volumes of the fuel gas inlet manifold, the air inlet manifold, the air outlet manifold, the coolant inlet manifold and the coolant outlet manifold, a much larger amount of impurities can be stored in the impurity storage section, and the frequency of discharge can be much further reduced.

According to the sixth aspect of the present invention, since a choke is formed in a communicating part that communicates the fuel gas inlet manifold and the anode gas passage of each cell, a pressure loss greater than the pressure loss that occurs in the anode gas passages can be produced in the communicating part. As a result, the difference in outlet pressure among the anode gas passages of the cells can be reduced, and back flow of impurities from the impurity storage section into the anode gas passages, which is caused by the difference in outlet pressure, can be prevented.

### BRIEF DESCRIPTION OF THE DRAWINGS

FIG. 1 is a schematic diagram showing a configuration of a fuel cell system according to an embodiment of the present invention; and

FIG. 2 is a cross-sectional view taken along the line A-A in FIG. 1, schematically showing an internal configuration of a cell and a phenomenon that occurs in the cell.

### BEST MODE FOR CARRYING OUT THE INVENTION

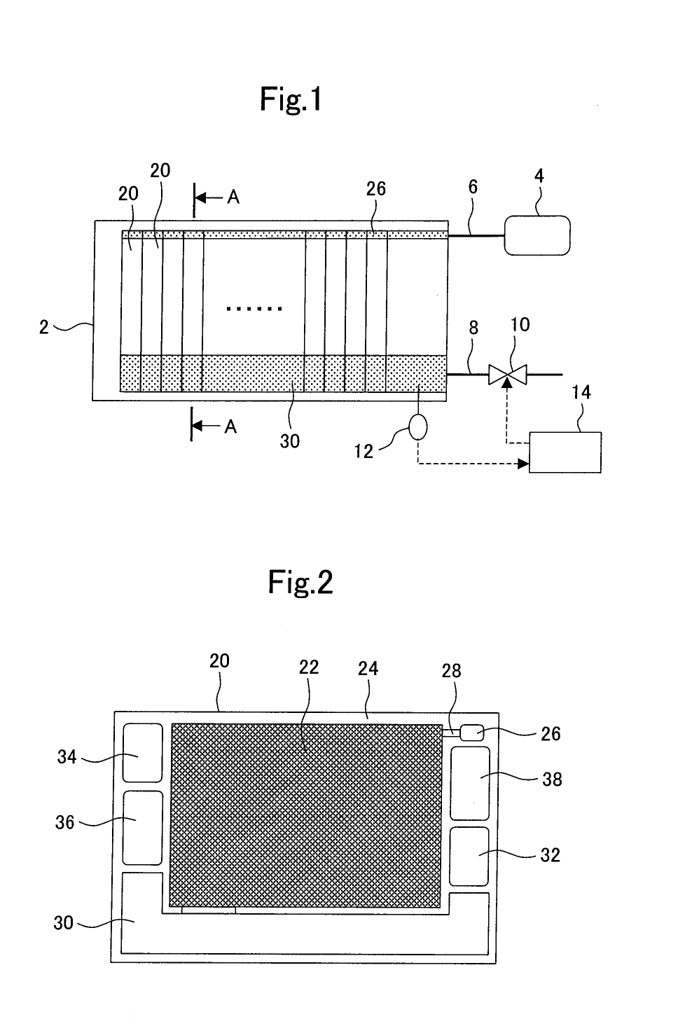

In the following, an embodiment of the present invention will be described with reference to FIGS. 1 and 2.

FIG. 1 is a schematic diagram showing a configuration of a fuel cell system according to an embodiment of the present invention. The fuel cell system has a fuel cell stack 2 for generating electric power and supplies the electric power to an electric load, such as a motor. The fuel cell stack 2 is composed of a plurality of cells 20, and the cells 20 are electrically connected in series with each other. Although not shown, each cell 20 has a membrane electrode assembly (MEA) interposed between a pair of current collectors. The MEA is a combination of a solid polymer electrolyte membrane, catalyst electrodes formed on the opposite surfaces of the electrolyte membrane, and gas diffusion layers, such as a carbon sheet, formed on both the catalyst electrodes. The current collectors serve as a separator between adjacent two MEAs. Each cell 20 generates electric power using a fuel gas (for example, hydrogen) supplied to the anode thereof and air supplied to the cathode thereof.

A fuel gas supply pipe 6 for supplying the fuel gas from a fuel gas supply source 4, such as a high pressure hydrogen tank, to the fuel cell stack 2 is connected to the fuel cell stack 2. The fuel gas supplied to the fuel cell stack 2 is distributed to anode gas passages of the cells 20 through a fuel gas inlet manifold 26 in the fuel cell stack 2 and used in the MEAs, which are electric power generating sections.

In the fuel cell stack 2, a fuel gas outlet manifold 30 that communicates with outlets of the anode gas passages of the cells 20 is formed. When the fuel cell stack 2 generates electric power, an amount of fuel gas to compensate for the consumption for electric power generation is supplied through the fuel gas inlet manifold 26, and therefore, a flow of the fuel gas occurs in the anode gas passages. The flow of the fuel gas causes an impurity in the anode gas passages (nitrogen having passed through the solid polymer electrolyte membranes from the cathode side) to accumulate in the fuel gas outlet manifold 30 downstream of the anode gas passages. The fuel cell system according to this embodiment is characterized in that the fuel gas outlet manifold 30 serves as an impurity storage section for storing an impurity in the fuel gas.

An exhaust pipe 8 connected to the fuel cell stack 2 communicates with the fuel gas outlet manifold 30. The exhaust pipe 8 has an exhaust valve 10 that opens and closes the path communicating the fuel gas outlet manifold 30 and the outside of the system. The exhaust valve 10 is opened and closed under the control of a controller 14. The fuel cell system according to this embodiment operates with the fuel gas confined in the fuel cell stack 2. In other words, the fuel cell system is a dead-end system. Therefore, the controller 14 maintains the exhaust valve 10 in the closed state during normal electric power generation and opens the exhaust valve 10 for an extremely short time only when a predetermined purge condition is satisfied. In this embodiment, the purge condition is that the concentration of hydrogen in the fuel gas outlet manifold 30 is lower than a predetermined reference value. The concentration of hydrogen in the fuel gas outlet manifold 30 is measured by a hydrogen concentration sensor 12 attached to the fuel cell stack 2.

In FIG. 1, the fuel gas outlet manifold 30 is significantly larger than the fuel gas inlet manifold 26. This means that the fuel gas outlet manifold 30 of the fuel cell system according to this embodiment has a significantly larger volume than the fuel gas inlet manifold 26. The dead-end system, such as the system according to this embodiment, only requires that an amount of fuel gas to compensate for the consumption by the fuel cell stack 2 be supplied to the fuel cell stack 2. Therefore, compared with a circulation-type system that circulates the fuel gas, the volume of the fuel gas inlet manifold 26, more specifically, the cross-sectional area thereof can be reduced. In this embodiment, the cross-sectional area of the fuel gas outlet manifold 30 is increased by the reduction of the cross-sectional area of the fuel gas inlet manifold 26.

FIG. 2 is a cross-sectional view taken along the line A-A in FIG. 1 and shows a configuration of a cell 20 forming the fuel cell stack 2, more specifically, a configuration of a separator (current collector) 24. As described above, the cell 20 has a pair of separators 24 and an MEA interposed therebetween. The separator 24 has an anode gas passage 22 in an area to be in contact with the anode surface of the MEA. The shape and configuration of the anode gas passage 22 are not limited to any particular ones. For example, a groove formed in the surface of the separator 24 can be used as the anode gas passage 22. Alternatively, a porous layer made of a conductive material can be formed, and the pores in the porous layer communicating with each other can be used as the anode gas passage 22.

The anode gas passage 22 is located at the center part of the separator 24, and a plurality of openings 26, 30, 32, 34, 36 and 38 are formed along the rim of the separator 24 to surround the anode gas passage 22. One of the openings is the fuel gas inlet manifold 26 described above, and another is the fuel gas outlet manifold 30. The fuel gas inlet manifold 26 communicates with the inlet of the anode gas passage 22, and the fuel gas outlet manifold 30 communicates with the outlet of the anode gas passage 22. The other openings are an air inlet manifold 32, an air outlet manifold 34, a coolant inlet manifold 36, and a coolant outlet manifold 38.

As shown in FIG. 2, the fuel gas outlet manifold 30 has a cross-sectional area (opening area) significantly larger than those of the other manifolds 26, 32, 34, 36 and 38. More specifically, the cross-sectional area of the fuel gas outlet manifold 30 is larger than the sum of the cross-sectional areas of the other manifolds 26, 32, 34, 36 and 38. Since the cross-sectional area of each manifold does not change in the direction of stacking of the cells 20, when each manifold is shaped as shown in FIG. 2, the fuel gas outlet manifold 30 has a volume larger than the sum of the volumes of the other manifolds 26, 32, 34, 36 and 38.

The large volume of the fuel gas outlet manifold 30 provides a large dead volume between the outlet of the anode gas passage 22 and the exhaust valve 10. Therefore, the impurity in the fuel gas produced in the anode gas passage 22 can be guided into the dead volume and stored therein, thereby reducing the increase of the concentration of the impurity in the anode gas passage 22. Alternatively, the fuel cell stack 2 can be provided with an external storage container to provide the dead volume. However, in that case, the number of components increases, and the space for the storage container has to be provided. To the contrary, if the dead volume for storing the impurity is provided in the fuel cell stack 2 as in this embodiment, the fuel cell stack 2 does not have to have a separate space for storing the impurity. Therefore, the entire system can be simple in configuration and compact in size.

If the increase of the concentration of the impurity in the anode gas passage 22 is reduced, the frequency of discharge of the off-gas of the fuel gas from the fuel cell stack 2 decreases. In this embodiment, the exhaust valve 10 is opened when the concentration of hydrogen in the fuel gas outlet manifold 30 becomes lower than the reference value. However, since the fuel gas outlet manifold 30 has a large volume, it takes long for the impurity to accumulate in the fuel gas outlet manifold 30 and for the hydrogen concentration to decrease to the reference value. Therefore, the frequency of opening of the exhaust valve 10 for purging decreases, and waste of the fuel gas is reduced accordingly.

The fuel cell system according to this embodiment is further characterized in that a choke 28 is formed in the communicating part that communicates the fuel gas inlet manifold 26 and the anode gas passage 22. Because of the choke 28, a pressure loss occurs when the fuel gas flows from the fuel gas inlet manifold 26 into the anode gas passage 22. The amount of the pressure loss can be adjusted by the diameter of the choke 28. In this embodiment, the choke 28 has a diameter that allows the pressure loss that occurs at the choke 28 to be at least ten times greater than the pressure loss that occurs in the anode gas passage 22.

The amount of the pressure loss that occurs in the anode gas passage 22 varies with the cell 20, and the pressure at the outlet of the anode gas passage 22 also varies with the cell 20 according to the variation of the pressure loss. When the anode gas passages 22 have different outlet pressures, the impurity can flow back into an anode gas passage 22 having a low outlet pressure from the fuel gas outlet manifold 30. However, if the choke 28 at the inlet of each anode gas passage 22 produces a great pressure loss as in this embodiment, the difference in outlet pressure among the anode gas passages 22 due to the difference in pressure loss among the anode gas passages 22 decreases, and the back flow of the impurity from the fuel gas outlet manifold 30 into the anode gas passages 22 due to the difference in outlet pressure can be prevented.

While an embodiment of the present invention has been described above, the present invention is not limited to the embodiment described above, and various variations can be made without departing from the spirit of the present invention. For example, the following variations are possible.

The volume of the fuel gas outlet manifold has to be at least larger than the volume of the fuel gas inlet manifold. However, preferably, the volume of the fuel gas outlet manifold is larger than the sum of the volumes of the fuel gas inlet manifold, the air inlet manifold and the air outlet manifold. Most preferably, as in the embodiment described above, the volume of the fuel gas outlet manifold is larger than the sum of the volumes of all the other manifolds.

While the large volume of the fuel gas outlet manifold is used as an impurity storage section in the embodiment described above, any other space that is formed in the fuel cell stack and communicates with the outlets of the anode gas passages of the cells can be used as the impurity storage section. In that case, the space can communicate with the outlets of the anode gas passages directly or via the fuel gas outlet manifold.

While the basic operation of the fuel cell system is the dead-end operation in which the exhaust valve is completely closed in the embodiment described above, the basic operation can also be a continuous small discharge operation in which the exhaust valve is slightly opened. In the continuous small discharge operation, the fuel gas is substantially confined in the fuel cell stack during operation as in the dead-end operation, and the opening of the exhaust valve is adjusted so that the amount of the off-gas discharged to the outside of the system is extremely lower than the consumption of the fuel gas in the fuel cell stack. In the continuous small discharge operation, the impurity stored in the fuel gas outlet manifold can be discharged little by little to the outside of the system, so that the impurity can continue to move from the anode gas passages to the fuel gas outlet manifold. Therefore, the concentration of the impurity in the anode gas passages can be maintained at low level.

1. A fuel cell system that has a fuel cell stack including a plurality of cells and operates with a fuel gas used by each cell for electric power generation effectively confined in said fuel cell stack, wherein an impurity storage section for storing an impurity in the fuel gas that communicates with an outlet of an anode gas passage of each cell and a fuel gas inlet manifold for distributing the fuel gas supplied from the outside of said fuel cell stack to the anode gas passages of the cells are formed in said fuel cell stack, and the volume of said impurity storage section is larger than the volume of said fuel gas inlet manifold.

2. The fuel cell system according to claim 1, wherein the fuel cell system has a communicating mechanism that allows said impurity storage section to communicate with the outside of said fuel cell stack.

3. (canceled)

4. The fuel cell system according to claim 1, wherein an air inlet manifold for distributing air supplied from the outside of said fuel cell stack to cathode gas passages of the cells and an air outlet manifold for discharging air collected from the cathode gas passages of the cells to the outside of said fuel cell stack are formed in said fuel cell stack, and the volume of said impurity storage section is larger than the sum of the volumes of said fuel gas inlet manifold, said air inlet manifold and said air outlet manifold.

5. The fuel cell system according to claim 4, wherein a coolant inlet manifold for distributing a coolant supplied from the outside of said fuel cell stack to coolant passages of the cells and a coolant outlet manifold for discharging the coolant collected from the coolant passages of the cells to the outside of said fuel cell stack are formed in said fuel cell stack, and the volume of said impurity storage section is larger than the sum of the volumes of said fuel gas inlet manifold, said air inlet manifold, said air outlet manifold, said coolant inlet manifold and said coolant outlet manifold.

6. The fuel cell system according to claim 1, wherein a choke is formed in a communicating part that communicates said fuel gas inlet manifold and the anode gas passage of each cell.
